(19) United States
(12) Patent Application Publication
(10) Pub. No.: US 2025/0286605 A1
(43) Pub. Date: Sep. 11, 2025

(54) ACTIVE ANTENNA SYSTEM FOR RADIO TERMINAL DEVICE

(71) Applicant: Dimitris KOLOKOTRONIS, Athens (GR)

(72) Inventor: Dimitris KOLOKOTRONIS, Athens (GR)

(21) Appl. No.: 18/600,818

(22) Filed: Mar. 11, 2024

(51) Int. Cl. H04B 7/15; H04W 72/1273; H04W 72/21

(52) U.S. Cl. CPC H04B 7/15; H04W 72/1273; H04W 72/21

(57) ABSTRACT

An RF repeater (1000) comprising one or more antennas (500), one or more radio terminal device connection ports (1004) for direct, wired connection to a radio terminal device (100), one or more uplink channels (1014) between the one or more antennas and the one or more radio terminal device ports, the one or more uplink channels for carrying an uplink signal and one or more downlink channels (1012) between the one or more antennas and the one or more radio terminal device ports, the one or more downlink channels for carrying a downlink signal. The repeater has repeater circuitry (1016, 1018, 1020) configured to provide one of the downlink channel signal and uplink channel signal with a net positive gain and provide the other of the downlink channel signal and uplink channel signal with a net zero gain or net negative gain.

### TECHNICAL FIELD

This invention relates to an active antenna system for a radio terminal device (RTD) operating on a wireless telecommunication network. Specifically, this invention relates to an antenna system that utilizes one or more amplify and forward RF repeaters, which directly connect to either a radio terminal device in order to boost the downlink channel signal strength as such to optimize the downlink service performance (radio base station to radio terminal device) or a radio base station in order to boost the uplink channel signal strength as such to optimize the uplink service performance (radio terminal device to radio base station) of a wireless telecommunication network.

### BACKGROUND ART

In order to address weak or poor wireless connections, external antenna systems on radio terminal devices are often used. By external antenna systems we mean that the antennas are not embedded in the device. A radio terminal device (RTD) is defined herein as the device that connects with at least one network radio base station (RBS) to transfer data therebetween by radio signal transmission. Examples of radio terminal devices that may utilize such antennas and operate on wireless telecommunication networks include modem/routers, customer premises equipment (CPE), cellular phones, smart phones, laptops, tablets, access points (APs), internet of things (IoT) devices and any other similar radio network terminal device.

In modern wireless technology networks such as LTE and 5G, the radio terminal device is commonly referred to as user equipment (UE), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. When radio terminal devices utilize external antennas, those are usually deployed via a physical coaxial connection between the antenna and the radio terminal device in use.

A SISO (Single Input Single Output) radio terminal device (RTD) 120 connected via a coaxial port 110 with an external antenna 100 to a wireless telecommunication network radio base station (RBS) 130 is shown in FIG. 1a. External antennas in principle (due to the designed dimensions), have better electrical characteristics than their embedded equivalent therefore, it is known that external antennas have improved connectivity performance compared to embedded antennas. FIGS. 1b and 1c show a MIMO (Multiple Input Multiple Output) on a 2 data stream (2 antennas 100′) and 4 data stream (4 antennas 100″) configuration respectively. Radio terminal devices 120′, 120″ using higher order MIMO utilize a higher number of antennas with an aim to utilize more data streams as such to further improve the service performance of a wireless telecommunication network.

External antennas of omnidirectional or directional radiation patterns can be deployed on the radio terminal devices. Such antennas are off-the-shelf and can be selected out of a plurality. Multiple external antennas are required to be deployed at predetermined E-plane polarization or λ-multiple spacing in order that signal transmissions and receptions from each antenna are uncorrelated for MIMO to perform. Antennas are required to support the frequency bands of operation of the serving radio base station 130 of the wireless telecommunication network and the radio terminal device in use. Radio terminal devices that operate with carrier aggregation and/or at multiple frequency bands require broadband antenna systems when a single port is offered for antenna connectivity (combined/multiplexed at the radio terminal device).

Teltonika™ RUTX50 is a 4×4 MIMO radio terminal device that supports carrier aggregation on multiple LTE technology frequency bands, among others. Since RUTX50 is a 4×4 MIMO radio terminal device, it requires 4 broadband antennas in order to fully utilize its carrier aggregation capabilities. The external antennas recommended by Teltonika for this radio terminal device are of omnidirectional radiation pattern that directly connect on the device's external antenna ports. Such omnidirectional antennas are broadband, thus they support carrier aggregation and multiple frequency bands, but are of low gain and efficiency, without any directivity (omnidirectional gain pattern), meaning that the radio link suffers from both poor signal strength (result of the antenna gain/efficiency, especially when they are installed indoors or at low height from the ground) and interference (result of the antenna directivity, especially when there are neighbouring radio base station receptions at the receiver location). Low received signal strength of high interference and noise (increased noise floor is observed at devices operating on broadband technologies) is the worst combination on a radio link as both define a bad signal to interference and noise ratio (SINR) on the established wireless connections.

A wireless connection may achieve from the network maximum speeds and data throughputs when the signal to interference and noise ratio (SINR) of the radio links formed between the radio base station and the radio terminal devices in use are capable of supporting the highest modulation and coding scheme (MCS) of the technology they operate. In order for the radio base station signal to be demodulated by the receiver of the radio terminal device (criterion for achieving connectivity), it needs to be greater in power than the sensitivity of the receiver (i.e. the minimum power that the receiver can distinguish the signal from the noise and decode it). The sensitivity of a receiver (or its noise floor) is equal to FKTB, where F is the receiver's noise factor (linear), K is the Boltzmann constant, T is the temperature in kelvin and B is the receiver's operating bandwidth in Hertz). Having said that, the receiver thermal noise power level operating on a 20 MHz channel bandwidth at room temperature (kTB for T=290° Kelvin and B=20 MHz) is −100.96 dBm (logarithmic). Therefore, the sensitivity of our receiver would be −100.96 dBm plus the noise figure (in dB) introduced by the receiver circuitry itself.

In an exemplary LTE technology wireless telecommunication network of 20 MHz channel bandwidth, 29 different modulation and coding schemes (MCS) are supported, each offered at wireless connections of different minimum signal to noise and interference ratios (LTE/5G or similar technologies that operate/utilize radio link adaptation features). The highest modulation and coding scheme—MCS—is attributed to radio links established between radio base stations and radio terminal devices that meet corresponding conditions of signal strength, interference and noise levels.

| MCSl | Mod & CR | SINR | | Sensitivity | | Total Bit Rate | | Real Bit Rate | |
|---|---|---|---|---|---|---|---|---|---|
| 0 | QPSK 0.117 | −3.98 | dB | −101 | dBm | 2.79 | Mbps | 2.05 | Mbps |
| 1 | QPSK 0.153 | −2.68 | dB | −100 | dBm | 3.62 | Mbps | 2.66 | Mbps |
| 2 | QPSK 0.189 | −1.63 | dB | −99.1 | dBm | 4.58 | Mbps | 3.37 | Mbps |
| 3 | QPSK 0.245 | −0.27 | dB | −97.7 | dBm | 5.74 | Mbps | 4.21 | Mbps |
| 4 | QPSK 0.301 | 0.85 | dB | −96.6 | dBm | 7.22 | Mbps | 5.31 | Mbps |
| 5 | QPSK 0.37 | 2.03 | dB | −95.4 | dBm | 8.76 | Mbps | 6.44 | Mbps |
| 6 | QPSK 0.439 | 3.06 | dB | −94.4 | dBm | 10.30 | Mbps | 7.56 | Mbps |
| 7 | QPSK 0.514 | 4.06 | dB | −93.4 | dBm | 12.22 | Mbps | 8.98 | Mbps |
| 8 | QPSK 0.588 | 4.98 | dB | −92.5 | dBm | 14.11 | Mbps | 10.37 | Mbps |
| 9 | QPSK 0.663 | 5.84 | dB | −91.6 | dBm | 15.84 | Mbps | 11.64 | Mbps |
| 10 | 16QAM 0.332 | 6.34 | dB | −91.1 | dBm | 15.84 | Mbps | 11.64 | Mbps |
| 11 | 16QAM 0.369 | 7.14 | dB | −90.3 | dBm | 17.57 | Mbps | 12.91 | Mbps |
| 12 | 16QAM 0.424 | 8.24 | dB | −89.2 | dBm | 19.85 | Mbps | 14.58 | Mbps |
| 13 | 16QAM 0.479 | 9.29 | dB | −88.2 | dBm | 22.92 | Mbps | 16.84 | Mbps |
| 14 | 16QAM 0.54 | 10.40 | dB | −87 | dBm | 25.46 | Mbps | 18.70 | Mbps |
| 15 | 16QAM 0.602 | 11.48 | dB | −86 | dBm | 28.34 | Mbps | 20.82 | Mbps |
| 16 | 16QAM 0.643 | 12.17 | dB | −85.3 | dBm | 30.58 | Mbps | 22.46 | Mbps |
| 17 | 64QAM 0.428 | 13.17 | dB | −84.3 | dBm | 30.58 | Mbps | 22.46 | Mbps |
| 18 | 64QAM 0.455 | 13.85 | dB | −83.6 | dBm | 32.86 | Mbps | 24.14 | Mbps |
| 19 | 64QAM 0.505 | 15.06 | dB | −82.4 | dBm | 36.70 | Mbps | 26.96 | Mbps |
| 20 | 64QAM 0.554 | 16.25 | dB | −81.2 | dBm | 39.23 | Mbps | 28.82 | Mbps |
| 21 | 64QAM 0.602 | 17.40 | dB | −80 | dBm | 43.82 | Mbps | 32.19 | Mbps |
| 22 | 64QAM 0.65 | 18.53 | dB | −78.9 | dBm | 46.89 | Mbps | 34.45 | Mbps |
| 23 | 64QAM 0.702 | 19.74 | dB | −77.7 | dBm | 51.02 | Mbps | 37.49 | Mbps |
| 24 | 64QAM 0.754 | 20.93 | dB | −76.5 | dBm | 55.06 | Mbps | 40.45 | Mbps |
| 25 | 64QAM 0.803 | 22.07 | dB | −75.4 | dBm | 57.34 | Mbps | 42.13 | Mbps |
| 26 | 64QAM 0.853 | 23.20 | dB | −74.3 | dBm | 61.66 | Mbps | 45.31 | Mbps |
| 27 | 64QAM 0.889 | 24.03 | dB | −73.4 | dBm | 63.78 | Mbps | 46.86 | Mbps |
| 28 | 64QAM 0.926 | 24.87 | dB | −72.6 | dBm | 75.38 | Mbps | 55.38 | Mbps |

On the above Table it is observed that when in the receiver we have a minimum signal reception of −72.6 dBm and an SINR level of at least 24.87 dB, the network will support the highest MCSI (MCSI 28) and our exemplary LTE technology, for 20 MHz channel bandwidth, will offer the radio terminal device total service bit rates of 75.38 Mbps. It has to be noted herein that when the channel bandwidth multiplies, as this is the case for carrier aggregation or multi-frequency band operation, the aforementioned modulation and coding scheme (i.e. MCSI 28) for 40 MHz, 60 MHz or 80 MHz channel bandwidth, is expected to offer the radio terminal device total service bit rates of 150.76 Mbps (40 MHz), 226.14 Mbps (60 MHz) or 301.52 Mbps (80 MHz) respectively.

It is also observed that when in the receiver we have minimum signal reception of −101 dBm and an SINR level with value at least −3.98 dB, the network will support the lowest MCSI (MCSI 0) and our exemplary LTE technology, for the 20 MHz channel bandwidth, will offer the radio terminal device total service bit rates of 2.79 Mbps (or 5.58 Mbps, 8.37 Mbps and 11.16 Mbps for 40 MHz, 60 MHz and 80 MHz channel bandwidth respectively). For signal receiving levels of less than −101 dBm and/or SINR values less than −3.98 dB, the wireless telecommunication network does not offer any service to the radio terminal device. That is, in this case, for the same network resources (same spectrum/channel bandwidth), the change in service speeds/service (due to radio link performance) is huge.

This change depends solely on the levels of received signal power from the serving radio base station, the levels of the received interference (assuming a fine regulated market we should not account interference from external sources) and of course the noise introduced by the receiver circuitry of the radio terminal device itself.

Therefore, in order to ensure a radio link connection for our exemplary Teltonika™ RUTX50 radio terminal device with an LTE technology radio base station as such to achieve wireless connectivity at the best modulation and coding scheme offered by the network, one has primarily to account for the best possible signal strength to interference strength and noise power receptions. Knowing that for the 20 MHz channel bandwidth the receiver sensitivity is at least the receiver thermal noise power which is calculated to be at −100.96 dBm (assuming the ideal condition that interference as well as receiver system noise are of zero power contribution) the received signal strength at the radio terminal device should be at least 25 dB more than the receiver sensitivity (as such to get SINR of 25 dB, i.e. −100.96 dBm+25 dB=−75.96 dBm) and achieve optimum network connectivity (i.e. high MCS Index) of high speeds and data throughput rates. When assuming that in our exemplary scenario we considered only the thermal noise power of a perfect receiver, we may easily understand that signal strength levels at the presence of interference (usually the case) and the increased noise from the anticipated receiver circuitry imperfections, the radio base station received signal strength levels required at the radio terminal device becomes even more demanding.

It has to be noted at this point that on average for every single dB less, the referenced optimum received signal strength level drags the MCS index (0-28) at a lower level, offering the wireless connection reduced code rates (spectrum efficiency) with direct result the drop of the radio terminal device total service bit rate. Adding to the ‘ideal’ sensitivity of the radio terminal device receiver (which is −100.96 dBm for 20 MHz channel bandwidth) the noise figure of a typical receiver circuitry (for example a 3 dB noise figure−NF), the ‘actual’ receiver sensitivity will become −97.96 dBm (−100.96 dBm+3 dB=−97.96 dBm). Therefore, in order to achieve the required 25 dB signal to interference and noise ratio (SINR=25 dB), assuming an interference free environment, the needed received signal strength at the radio terminal device should be at least-72.96 dBm. Taking into account that most of the radio terminal devices, as our exemplary Teltonika™ RUTX50, are located indoors we expect that rarely the device will achieve such received signal strength levels, especially with the low gain omnidirectional antenna systems that these radio terminal devices are equipped. This is undesired.

### Prior Art Amplify and Forward (AF) Repeaters

An option to boost the radio signal strength at the radio terminal device is to use an amplify and forward (AF) bi-directional (or “two-way”) RF repeater. An AF repeater, also known as an RF signal booster or RF signal amplifier, is a device designed to improve signal strength reception in areas with weak or unreliable wireless coverage. An example AF repeater 150 is shown schematically in FIG. 1d. It consists of three main components which namely are an external or donor antenna 152, a bi-directional signal amplifier 154 and an internal or service antenna 156. The external antenna 152 is placed outside a building or vehicle (see wall 158 separating interior 160 from exterior 162) to capture the existing weak radio signal from the RBS 130 to be re-transmitted. This antenna 152 is usually mounted on the roof or a high point outdoors, as such to maximize signal reception and to provide the required isolation from the service antenna 156. The captured radio base station signal from the donor antenna (downlink) and the captured radio terminal device signal from the service antenna (uplink) are directed to the bi-directional (downlink and uplink) signal amplifier system. The amplifier system boosts the signal's strength of both downlink and uplink significantly (as such to compensate the air interface or “off-air” RF signal losses), making them stronger and more reliable within its intended coverage area. The internal service antenna 156 is positioned inside the building or vehicle to re-transmit the downlink amplified signal to the wireless device(s) within its range and the uplink amplified signal towards the donor radio base station. Using an amplify and forward (AF) bi-directional (or “two-way”, downlink and uplink) RF repeater allows smartphones, CPEs, modem/routers, IoT and other radio terminal devices such as Teltonika™ RUTX50 to connect to a stronger signal, resulting in improved network accessibility (but not necessarily on improved network speeds and data throughput rates).

There are several problems with known two-way amplify and forward (AF) repeaters that cannot offer a radio terminal device with improved network speeds and data throughput rates. Some of the problems are outlined below:
MIMO efficiency and performance;
Carrier Aggregation (CA) or multi-frequency band operation; and,
Donor and service antenna isolation and de-coupling.

RF repeaters, although offering improved network accessibility (particularly useful in areas with poor wireless coverage, such as rural locations, remote areas, or buildings with thick walls that can totally block signals), are not intended to be used in order that a radio terminal device achieves high network speed and data throughput rate connectivity. On the contrary, although the use of an RF repeater will boost radio signal reception, as such the needed received signal strength at the radio terminal device of our previous example to match the targeted threshold, the network performance is expected to degrade. The main reason for such degradation is the fact that amplify and forward (AF) bi-directional (or “two-way”) RF repeaters do not optimally utilize MIMO technology and carrier aggregation (or multi-frequency band operation), both of which feature prominently in modern 4G, 5G and other wireless network implementations in order to offer increased radio base station capacity and broadband experience.

Further, since RF repeaters boost any radio signal within their frequency band of operation (as received at their input), depending on the donor antenna type deployed (i.e. omnidirectional), any interference signals present competing with the desired signal for re-transmission will be equally boosted (depending on the received signal strength levels of the dominant radio base station and the interference radio base station(s) at the antenna, the SINR levels at the radio terminal device after the RF repeater re-transmission are accordingly degraded). Turning on the Teltonika's™ RUTX50 radio terminal device, we may see that the external antennas recommended by Teltonika for this device are of omnidirectional radiation pattern, meaning that for small difference on the received signal strength levels from both the dominant radio base station and the interference radio base station(s), the signal to interference and noise ratio will be significantly impacted, resulting to radio terminal device service degradation. Due to the aforementioned reasons, collecting network signals using omnidirectional antennas is clearly undesirable.

It will be noted that the applicant's previous patent applications such as those described in published WO 2016/087431 A1, WO 2024/017902 A1 and unpublished GB2308012.0, which are hereby incorporated by reference where permitted, deal with this problem by reducing the received signal strength levels of the interference radio base station(s) directly at the antenna, especially on moving vehicles, by replacing the omnidirectional antenna with a directional antenna targeting towards one (or more) selected radio base station direction.

Mimo Problems with Prior Art Amplify and Forward (AF) Repeaters

A single repeater destroys the MIMO de-correlation completely. This is due to the fact that an RF repeater may replicate the signal but it won't generate multiple independent data streams. Most RF repeaters have a limited number of antennas compared to a full MIMO setup. Two amplify and forward (AF) bi-directional (or “two-way”) RF repeaters are required to re-transmit 2 data streams (2× data stream MIMO), four amplify and forward (AF) bi-directional (or “two-way”) RF repeaters are required to re-transmit 4 data streams (4× data stream MIMO) and even such expensive and complex configurations will not offer full MIMO performance. MIMO systems require multiple transmit and receive antennas to create multiple spatial streams. The use of multiple donor (and service) antennas after radio signal re-transmission by the RF repeaters indoor, even when the received signals have been decorrelated from the multiple donor antenna (outdoor decorrelation) and the radio terminal device receiver antennas (indoor decorrelation) will not offer the MIMO performance of either the outdoor or indoor decorrelation alone. Mathematically you always “lose” on this combined outdoor/indoor decorrelation since the total radio signal decorrelation=outdoor*indoor decorrelation. So, if one achieves 0.8 outdoor decorrelation and 0.8 indoor decorrelation then overall one will get 0.8*0.8=0.64. That de-correlation is proportional to the SISO speed increase or MIMO speed=(1+decorrelation)*SISO speed so for 0.64 one should get a 1.64 MIMO speed instead of 1.80 for the 0.8 achieved from either outdoor or indoor decorrelation alone. It is well known that MIMO performance multiplies the radio terminal device network speeds and data throughput rates, depending on the number of MIMO order (i.e. SISO, 2×2 MIMO, 4×4 MIMO, etc) and the MIMO decorrelation performance. MIMO performance degradation is clearly undesirable when trying to achieve optimum radio terminal device connectivity of high network speeds and data throughput rates.

Carrier Aggregation ((a) Problems with Prior Art Amplify and Forward (AF) Repeaters

A single amplify and forward (AF) bi-directional (or “two-way”) RF repeater is not capable of supporting carrier aggregation or multi-frequency band operation. Most RF repeaters have limited capabilities in operating multiple frequency bands and those who have are very expensive for the intended application. Three band selective repeaters are required to get 3 frequency bands, six band selective repeaters are required to get 6 frequency bands and generally per frequency band, 1 band selective repeater is needed to re-transmit it. By band selection we mean that appropriate band-pass filters are used before the amplifiers in order to allow only the RF signals of selected bands to pass through the amplifier circuitry (i.e. the LTE band B1 FDD repeater will band-pass and amplify only 120 MHz bandwidth and in particular 60 MHz on uplink at 1920 MHz-1980 MHz and 60 MHz on downlink at 2110 MHz-2170 MHz frequencies). Along with the number of repeaters, goes the number of donor and service antennas, and generally per frequency band 1 separate narrowband antenna is required to collect and re-broadcast the radio signals (donor and service antennas). Other configurations that may operate at multiband donor and service antennas only, may require multiple, very expensive RF cavity duplexer or multiplexer filters to support the repeater's bi-directional high RF output power for multiband operation. It is well known that by aggregating multi-frequency bands (i.e. aggregating LTE B1/B3/B7 FDD frequencies-3CA) the radio terminal device network speeds and data throughput rates multiply, depending on the number of bands and bandwidths that have been aggregated. Failing to support carrier aggregation or multi-frequency band operation is clearly undesirable when trying to achieve optimum radio terminal device connectivity of high network speeds and data throughput rates. It should be noted herein that when aiming to support both carrier aggregation and MIMO technology on amplify and forward (AF) bi-directional (or “two-way”) RF repeaters makes things even more complicated and highly expensive.

Antenna Isolation Problems with Prior Art Amplify and Forward (AF) Repeaters

Last but not least, installing amplify and forward (AF) bi-directional (or “two-way”) RF repeaters requires specialized personnel as such to ensure that the donor and service antennas are properly positioned in order not to oscillate (donor/service antenna decoupling or isolation) and disrupt the re-transmitted radio signals. Decoupling, or isolating the donor and service antennas, is a critical consideration when installing RF repeater systems. RF repeater systems amplify signals significantly in order to achieve sufficient coverage boost for their intended application. If the donor and service antennas are too close or improperly aligned, the amplified signal from the service antenna can feed back into the donor antenna. This feedback can create an oscillation loop, leading to interference and signal disruption. Antenna decoupling helps prevent this. The primary method of achieving decoupling is to separate the donor and service antennas by a certain distance or physical RF obstacles. The required separation with distance or RF obstacles depends on various factors, including the specific RF repeater system gain and output power, the frequency bands used, and the surrounding environment. Antenna separation guidelines may differ depending on antennas selected and generally require specialized knowledge and tools in order to be optimally positioned. Installation complexity makes amplify and forward (AF) bi-directional (or “two-way”) RF repeaters generally undesirable.

Further, it should be noted herein that when aiming to properly install donor and service antennas that support both carrier aggregation and MIMO technology makes things even more complicated. Installation complexity of multiple donor and service antennas, that need to be isolated to each other and also positioned at predetermined E-plane polarizations or λ-multiple spacings such that signal transmissions and receptions of each is uncorrelated for MIMO to perform, is a complex and specialised operation.

FIG. 1e shows a distributed antenna system being directly connected (wired) to the RBS 130′. Such a configuration may be in place, for example, within an office or apartment block. The RBS 130′ is directly connected to a plurality of splitters 164₁-164_{N}, each of which is connected to a service antenna 166₁-166_{N}. Some of the antennas are close to the RBS, meaning RF losses through the coaxial cabling is relatively low. For others, it is high, and thus the low network speeds and high throughput rate problem identified above are present for those high pathloss service antennas.

It is the purpose of the present invention to use a “plug-n-play” amplify-and-forward (AF) RF repeater in order to achieve an inexpensive, optimum radio terminal device connectivity of high network speeds and data throughput rates, by fully utilizing MIMO and carrier aggregation technologies without encountering antenna isolation or de-coupling problems with effortless installation.

### SUMMARY OF INVENTION

According to a first aspect of the invention there is provided a repeater system comprising:
at least one antenna port;
at least one RTD/RBS port for direct, wired connection to a radio terminal device (RTD) or radio base station (RBS);
a plurality of band selective amplify and forward repeater circuits between the at least one antenna port and the at least one RTD/RBS port.

In one embodiment, each amplify and forward repeater circuit has net zero gain or negative gain on one channel path.

The present invention is therefore a direct connect “one-way” amplify and “two-way” forward repeater having the following advantages.

### “One-Way” Amplify and “Two-Way” Forward Direct Connect Repeaters

The aforementioned problems of the prior art are mitigated by the direct connection of one or more “one-way” amplify and “two-way” forward repeaters to the radio terminal device. By direct-connect we mean that the repeater will not utilize a service antenna to connect “off-air” with a radio terminal device, but instead it will be connected via a wire or coaxial cable. Advantageously, by directly connecting the RF repeater to the radio terminal device, and since the service antennas do not need to be deployed, isolating and decoupling by separating the donor and service antennas at a certain distance to each other is no longer required.

The repeater donor antennas are selected to be broadband to ensure carrier aggregation or multi-frequency band operation. The antennas are “matched” to the multiple operating frequency bands (broadband) required by the radio terminal device to perform. Suitable broadband antennas for the application are Log-Periodic, TEM-Horn, Vivaldi-Horn, Biconical and the like. Using the appropriate number of band selective repeaters i.e. per desired frequency band and for both downlink and uplink channels, multiplexed on a single connection port on the broadband antenna side and on a single connection port on the radio terminal device side one achieves the required repeater carrier aggregation or multi-frequency band operation.

Using the appropriate number of identical multiplexed band selective repeaters along with the desired MIMO configuration antennas (one per desired data stream positioned at predetermined E-plane polarizations or λ-multiple spacings) and identical coaxial cables for connecting the antennas with the multiplexed band selective repeaters and the multiplexed band selective repeaters with the radio terminal device, the required multiple independent decorrelated data streams of MIMO technology can be satisfied (either outdoor or indoor depending on where the donor antennas would be located).

Therefore, as with the installation complexity problem, the MIMO and carrier aggregation/multi-band operation of amplify and forward (AF) bi-directional (or “two-way”) RF repeaters is also tackled, theoretically allowing for optimum radio terminal device connectivity achieving high network speeds and data throughput rates.

In summary:
By directly connecting the amplify and forward (AF) repeaters to the radio terminal device antenna connection port the antenna isolation problem disappears.
By using the appropriate number of multiplexed band selective repeaters i.e. per desired frequency band and for both downlink and uplink channels, one achieves the required support of carrier aggregation or multi-frequency band operation; and,
By using multiple identical multiplexed band selective repeaters and connection cables along with the desired MIMO configuration antennas the required multiple independent data streams of MIMO technology can be satisfied;

It has to be noted at this point that since with the direct connection of the radio terminal device to the repeater we are not utilizing the service antenna, the “off-air” RF pathlosses between the repeater and the radio terminal device disappear, resulting in link budgets that require repeaters of low gain and output power. This has direct impact on the repeater's costs (i.e. low cost of duplexer and multiplexer filters, such as surface acoustic wave-SAW and bulk acoustic wave-BAW filters, among others), which make MIMO and carrier aggregation or multi-frequency band configurations inexpensive to deploy.

Therefore, the present invention mitigates the poor radio link connection problem that radio terminal devices located indoor or at remote/rural locations present, achieving wireless connectivity of high network speeds and high throughput rate, inexpensively. That said, the implementation of a bi-directional or two-way direct connect AF repeater of the prior art can cause several problems that are also addressed by the present invention.

Problems with Directly Connecting Bi-Directional Amplify and Forward (AF) Repeaters to the Radio Terminal Device

We know that the radio terminal device receiver (downlink channel path) has an RF circuitry that consist of low-noise-amplifiers (LNAs) that may amplify the incoming radio base station signals from the RF repeater without distortion (compression or saturation) only when those do not exceed a predefined power strength. We also know that the RF repeater at its uplink channel path has an RF circuitry that consist of low-noise-amplifiers (LNAs) that may amplify and forward the transmitted signals from the radio terminal device without distortion (compression or saturation) only when those do not exceed a predefined power strength. It is imperative that all LNAs on a radio communication system operate in a linear fashion. Linearity, in this context, refers to the amplifier's ability to faithfully reproduce its input signals without introducing non-linear distortions, due to compression or saturation.

Compression occurs when the amplifier reaches its maximum capacity to amplify signals, resulting in a compression of the signal amplitudes and potential loss of information.

Saturation, on the other hand, is a condition where the amplifier is pushed to its upper limit, causing distortion and the generation of harmonics.

To ensure optimal system functionality, maintaining the quality of the re-transmitted signals (on both downlink and uplink channel paths) is of paramount importance. Having said that, when directly connecting a prior art bi-directional RF repeater to a radio terminal device, the received downlink signal power (after amplification) should not exceed the radio terminal device LNA maximum input and output power (such RF signal input power threshold is at 10 dBm or 10 mW for most commercial radio terminal devices). At the same time, when directly connecting a radio terminal device to an RF repeater (uplink channel amplification), we should ensure that the transmitted uplink signal power should not exceed the repeater's LNA maximum input and output power threshold (such maximum power thresholds ranges depending on LNA choice). Last but not least, the standardized maximum transmit power of the radio terminal device at the RF repeater output should not exceed the standardized maximum of its category or class (i.e. the transmit power defined by 3GPP standards for LTE technology or similar standards for other technologies).

A bi-directional amplify and forward RF repeater offer signal gains on both downlink and uplink channel paths within a range of 50 dB to 100 dB (high gains are required in order to compensate the “on-air” RF pathlosses between the repeater's service antenna and the radio terminal device). Assuming that the received downlink signal power on the RF repeater input is less than-40 dBm the RF repeater at its output will not exceed the 10 dBm power threshold of the radio terminal device receiver maximum allowable input power and as such the downlink channel path will not encounter RF signal distortion (assuming an RF repeater circuitry of 50 dB gain). However, in the case that the received downlink signal power on the RF repeater input is greater than-40 dBm, or the RF repeater gain is higher than 50 dB, then the RF repeater at its output will exceed the 10 dBm maximum input power threshold of the radio terminal device receiver and as such the downlink channel path will encounter RF signal distortion (or the radio terminal device RF front-end circuitry will be damaged). Equivalent considerations for the amplify and forward (AF) repeater input/output circuitry should take place for the transmitted uplink signal power from the radio terminal device.

### Automatic Gain Control (AGC)

To tackle the aforementioned problem, known amplify and forward (AF) repeaters use Automatic Gain Control (AGC). AGC in RF repeaters functions to maintain a consistent and optimal signal strength level within the system despite fluctuations in the incoming signal strength. AGC systems continuously monitor/measure the strength of the incoming RF signal at the input to the repeater. If the incoming signal RF power strength varies, the AGC circuitry adjusts the LNA gains (i.e. by using variable gain amplifiers)—as such not to exceed the maximum output RF power of the LNAs, and/or the maximum input power (i.e. by using variable attenuators)—as such not to exceed the maximum input RF power at the LNAs. If the signal is weak, the AGC increases the gain (or reduces attenuation) of the LNAs, as such to amplify the signal output to the desired level. Conversely, if the signal is too strong, the AGC reduces the gain (or increases attenuation) to prevent distortion or overloading of the amplifiers. As such AGC manages to always maintain RF signal power at its outputs at a preset level.

However, although the use of AGC seems to overcome the LNA compression and saturation problem, directly connecting an amplify and forward (AF) bi-directional (or “two-way”) RF repeater to a radio terminal device remains highly problematic.

### Uplink Power Control (UPC)

Uplink power control (UPC) is a crucial feature in wireless communication systems, specifically designed for controlling the transmission power of radio terminal devices when they communicate with the radio base station. The primary goal of uplink power control is to ensure that radio terminal devices transmit their signals at an appropriate power level, optimizing system performance while conserving their battery life and reducing radio base station interference. Radio terminal devices at the cell edge may need to transmit at higher power levels to maintain connectivity, while those closer to the radio base station reduce their power levels as such to reduce their uplink interference contribution. This helps in balancing the uplink load across different pathloss radio terminal device connections in the radio base station cell coverage area. Several modern broadband technologies such as LTE and 5G employ adaptive power control mechanisms to adjust the transmission power of radio terminal devices dynamically. Their transmitted power level is not fixed but rather continuously adapted based on the channel conditions they encounter within a specified dynamic range. This dynamic range (in decibels—dB) is defined by the difference between the maximum and minimum power levels that a radio terminal device can use for uplink transmission. In our exemplary LTE technology network, uplink power control dynamic range typically spans 70 dB, from around-40 dBm (the minimum power level at which the radio terminal device can transmit) up to the standardized maximum of +23 dBm (the maximum power level at which the radio terminal device is allowed to transmit), through specific values that may vary slightly depending on transmission band and frequency range. Uplink power control fluctuates the radio terminal device power levels as such to optimize uplink channel connectivity within its dynamic range.

However, when we directly connect a radio terminal device to an amplify and forward (AF) bi-directional (or “two-way”) RF repeater, the transmitted signals in the uplink channel will lose the uplink power control feature when an AGC is used. Since the AGC manages to always maintain RF signal power at a preset level, the continuously adapted (based on the channel conditions) radio terminal device transmitted power will be firmly fixed by the AGC at a predefined maximum power strength at the output of the RF repeater. We know that uplink power control dynamic range ensures that radio terminal devices can adapt their transmit power according to their proximity to the radio base station site (low or high pathloss) and the quality of the uplink radio link (low or high interference). As a rule of thumb, radio terminal devices of low pathloss and low uplink interference (usually the case of low traffic/load cells) use low transmit power levels, while those of high pathloss and high interference (usually the case of high traffic/load cells) use higher transmit power levels to maintain a reliable connection. By directly connecting a radio terminal device to an amplify-and-forward (AF) RF repeater that operates with an AGC, irrespective of the radio terminal device pathloss and uplink interference, the uplink power control feature of the device will be virtually disabled, and any transmit power dynamic range will be lost. Disabling uplink power control is very problematic for the radio access network since such radio terminal devices become uplink “over-shooters” at least for their serving radio base stations. This is particularly important especially on moving vehicles that continuously change their radio channel conditions (i.e. assume the radio base station uplink interference from a vehicle that is having very low RF pathloss but transmits at its maximum power).

Advantageously, by using a “net-zero” or negative gain circuitry instead of an AGC at the RF repeater uplink channel path, the radio terminal device (RTD) power control feature on the uplink channel is not compromised, the quality of the re-transmitted signal is maintained without distortion due to LNA compression or saturation, while at the same time the maximum transmitted power of the radio terminal device does not exceed its standardized maximum power levels.

It will be understood that the invention uses an amplify-and-forward (AF) RF repeater in order to achieve optimum radio terminal device connectivity of high network speeds and data throughput rates by fully utilizing MIMO and carrier aggregation technologies without encountering antenna isolation or de-coupling problems, without disabling the uplink power control feature of the radio terminal device in use, while at the same time safeguarding the RF repeater's circuitry in the uplink channel from signal distortion. Last but not least, the present invention also ensures that the standardized maximum transmit power of the radio terminal device will not be exceeded.

The RF repeater of the present invention is a “one way” amplify and “two-way” forward repeater. By “one-way” amplify we mean that the direct connect amplify-and-forward (AF) repeater is amplifying (providing a net gain) only in one signal direction (i.e. the radio base station to radio terminal device direction or vice versa). It will be appreciated that since a transmitter (i.e. the radio terminal device) is directly connected on the broadband antenna (via the repeater circuitry), the repeater does not need an amplifier to forward the transmitted signals from the connected transmitting device. By “two-way” forward we mean that the uplink and downlink channels are forwarded to the antenna and RTD ports respectively.

By amplifying the downlink channel one may improve the radio terminal device downlink connectivity to achieve from the serving network higher download speeds and data throughput rates capable of supporting an optimized modulation and coding scheme (MCS) of the technology and frequency they operate especially on indoor or remote/rural environments. On a different configuration, i.e. on a radio base station distributed antenna system-DAS, by amplifying the uplink channel directly on the service antenna, one may improve the radio terminal device uplink connectivity and achieve from the serving network higher upload speeds and data throughput rates capable of supporting an optimized modulation and coding scheme (MCS) of the technology they operate.

The “one way” amplify and “two-way” forward repeater operates with “net-zero” or negative gain on the uplink channel (i.e. the signal transmission from the radio terminal device to the radio base station direction). By “net-zero” or negative gain on the uplink channel we mean that the uplink transmitted signal has a zero or negative gain difference between the transmitting output port of the radio terminal device and the connected donor antenna. Practically, the direct connect amplify-and-forward (AF) repeater should operate as “one-way” or single directional gain repeater, in order not to exceed the standardized maximum transmitted power of the radio terminal device, while maintaining the power control mechanism (uplink channel) of the radio terminal device in use. It has to be noted at this point that in LTE (FDD) technology, according to the relevant 3GPP standards, the maximum allowable transmitted power of a Category 3 to 24 radio terminal device is 23 dBm or ˜200 mW (such limits for the maximum transmitted power for the radio terminal device applies to any standardized wireless telecommunication technology).

Although the downlink and uplink channels, due to different gain on downlink and uplink channel paths are clearly unbalanced, in use, the radio terminal device uplink power control feature balances the links during the call initiation process.

We know that when a radio terminal device initiates a call or data session in our exemplary LTE network (or any other radio technologies that utilize uplink power control mechanisms), it goes through an initial access procedure. During this phase, the radio terminal device communicates with the serving radio base station to establish a connection. The radio terminal device sends a random access preamble to the radio base station. The radio base station responds by assigning a temporary identifier (RA-RNTI) to the radio terminal device and allocates resources for further communication. After this initial access, the radio base station continuously monitors the quality of the signal received from the radio terminal device. Based on this received signal quality, the radio base station sends power control commands (TPC—Transmit Power Control commands) to the radio terminal device. The TPC commands instruct the radio terminal device to adjust its uplink transmit power. If the received signal at the radio base station is weak, the TPC commands indicate the radio terminal device to increase its transmit power. Conversely, if the signal is strong enough, the TPC commands advise the radio terminal device to decrease its transmit power. ULPC operates on a continuous basis, with the radio terminal device adjusting its transmit power in response to the TPC commands received from the radio base station. This uplink power control dynamic adjustment helps the “one way” amplify and “two-way” forward repeater to operate with “net-zero” or negative gain on the uplink channel while maintaining the downlink and uplink paths balanced up to a pathloss that the radio link between the radio base station and the radio terminal device becomes uplink limited.

In one embodiment the RTD/RBS port is an RTD port for direct, wired connection to a radio terminal device (RTD).

In one embodiment each amplify and forward repeater circuit has net zero gain or negative gain on the uplink channel path.

The repeater system may comprise:
a plurality of antenna ports;
a plurality of RTD ports;
to support MIMO operation.

For example the system may comprise two antenna ports and two RTD ports to support 2 data streams for MIMO operation. The system may comprise four antenna ports and four RTD ports to support 4 data streams for MIMO operation.

In one embodiment the channel path with net zero gain or negative gain comprises an amplifier. The channel path with net zero gain or negative gain may comprise an attenuator in-line with the amplifier.

Each of the plurality of band selective amplify and forward repeater circuits may have negative gain on one channel path, wherein said channel path does not have an amplifier, the other channel path comprising an amplifier.

In one embodiment an RTD is connected to the at least one RTD/RBS port, wherein the plurality of band selective amplify and forward repeater circuits are configured such that the uplink signal power at the at least one antenna port is the same as the uplink signal power at the at least one RTD/RBS port.

In an alternative embodiment an RTD connected to the at least one RTD/RBS port, wherein the plurality of band selective amplify and forward repeater circuits are configured such that the uplink signal power at the at least one antenna port is less than the uplink signal power at the at least one RTD/RBS port.

The invention also provides a self-contained repeater unit comprising:
a repeater system according to the first aspect;
a radio terminal device (RTD) connected to the at least one RTD/RBS port;
an antenna connected to the at least one antenna port.

The radio terminal device (RTD) and the repeater system may be contained in a housing attached to the antenna. The radio terminal device (RTD) and the repeater system may be contained in a housing attached to the antenna mounting plane. The self-contained repeater unit is preferably mountable on an elongate member for azimuth steering as a single unit.

The one or more antennas may comprise one or more directional antennas.

The self-contained repeater unit according may comprise a plurality of antennas positioned at predetermined E-plane polarizations or λ-multiple spacings.

The housing is preferably IP rated.

The radio terminal device may be customer premises equipment (CPE). The customer premises equipment (CPE) may be a modem/router or the radio terminal device may be an IoT device.

The invention also provides a distributed antenna system comprising a repeater system according to the first aspect, a radio base station (RBS) connected to the at least one RTD/RBS port, and a service antenna connected to the at least one antenna port, wherein each amplify and forward repeater circuit has net zero gain or negative gain on the downlink channel path between the RBS and the service antenna.

The invention also provides a repeater assembly comprising a repeater system according to the first aspect, a two-way repeater connected to the at least one RTD/RBS port and a donor antenna connected to the at least one antenna port, wherein each repeater system has negative gain on the uplink channel path between the two-way repeater and the donor antenna.

The invention also provides a repeater antenna system, comprising a scanning antenna system comprising one or more scanning antennas, wherein the one or more scanning antennas are configured to receive, for at least a first azimuth heading value and a second azimuth heading value, data comprising mobile communication signal and network parameters, a donor antenna system comprising one or more antennas, wherein the one or more antennas are configured to receive and transmit mobile communication signals, wherein the donor antenna system is connected to a repeater system according to the first aspect, and a controller connected to the scanning antenna system and the repeater system, wherein the controller is configured to receive, process and compare the received mobile communication signals for the at least first azimuth heading value and the second azimuth heading value, determine whether the first azimuth heading value or the second azimuth heading value provides optimal network and signal parameters according to predefined criteria, and control connectivity of the repeater system with the one or more donor antennas of the donor antenna system in accordance with the determination.

The invention provides a multi-directional antenna system for a hotspot, the system comprising a plurality of directional donor antennas, each antenna oriented in a different direction such that each antenna has a different dominant radio base station in use, at least one repeater system according to the first aspect, wherein each directional donor antenna is connected to the at least one repeater system.

The invention provides a self-organizing directional antenna system, comprising a scanning antenna having a first horizontal beam width, the first antenna connected to a processor configured to establish communication between the scanning antenna and a radio base station (RBS), a radio terminal station (RTS), an RTS antenna system comprising at least one RTS antenna, the at least one RTS antenna having a second horizontal beam width, the second horizontal beam width being narrower than the first horizontal beam width, a repeater system according to the first aspect, the at least one RTS antenna connected to the at least one antenna port, and, a controller configured to, receive data identifying a RBS, determine the location of the RBS, using the location of the RTS antenna, and the position of the RBS, control the RTS antenna system to connect the RTS antenna to the RBS.

### BRIEF DESCRIPTION OF DRAWINGS

The present invention will now be described with reference to the following figures in which:

FIGS. 1a to 1e are schematic views of prior art devices;

FIG. 2a is a schematic view of a first “one way” amplify and “two-way” forward repeater apparatus according to the present invention;

FIG. 2b is a schematic view of a variation of the “one way” amplify and “two-way” forward repeater of FIG. 2a;

FIG. 2c is a schematic view of a further variation of the “one way” amplify and “two-way” forward repeater of FIG. 2a;

FIG. 2d is a schematic view of a still further variation of the “one way” amplify and “two-way” forward repeater of FIG. 2a;

FIG. 3 is a schematic view of a second “one way” amplify and “two-way” forward repeater apparatus according to the present invention;

FIG. 4 is a schematic view of a third “one way” amplify and “two-way” forward repeater apparatus according to the present invention;

FIG. 5a is a schematic view of a fourth “one way” amplify and “two-way” forward repeater apparatus according to the present invention having dual datastream MIMO;

FIG. 5b is a schematic view of a variation of the fourth “one way” amplify and “two-way” forward repeater with four data stream MIMO;

FIG. 6 is a schematic view of a sixth “one way” amplify and “two-way” forward repeater apparatus according to the present invention;

FIG. 7 is a schematic view of a seventh “one way” amplify and “two-way” forward repeater apparatus according to the present invention;

FIGS. 8a & 8b is a view of a first antenna apparatus comprising a “one way” amplify and “two-way” forward repeater according to the present invention;

FIGS. 9a & 9b is a view of a second antenna apparatus comprising a “one way” amplify and “two-way” forward repeater according to the present invention; and,

FIG. 10 is a schematic view of an eighth “one way” amplify and “two-way” forward repeater apparatus in accordance with the invention.

### DESCRIPTION OF THE FIRST EMBODIMENT

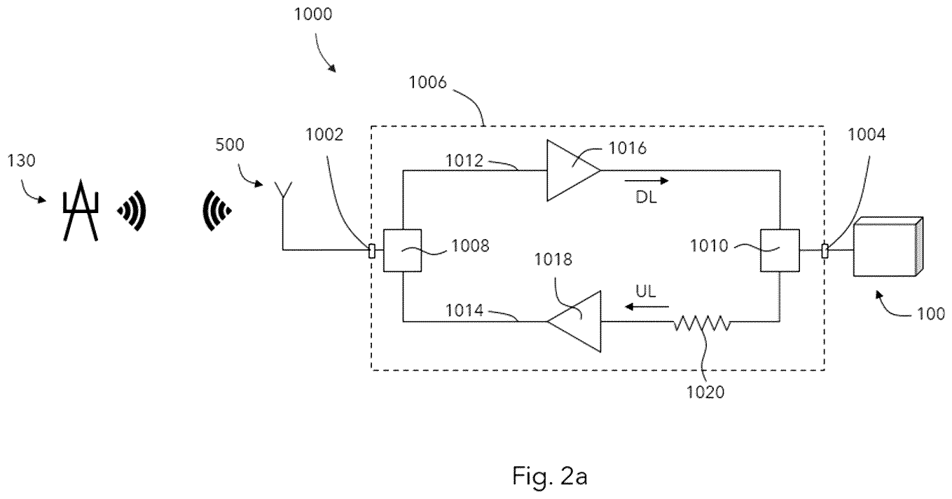

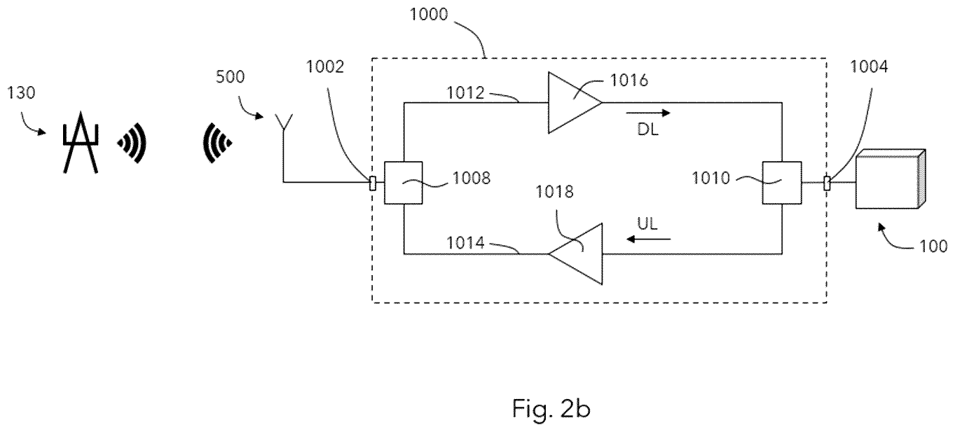

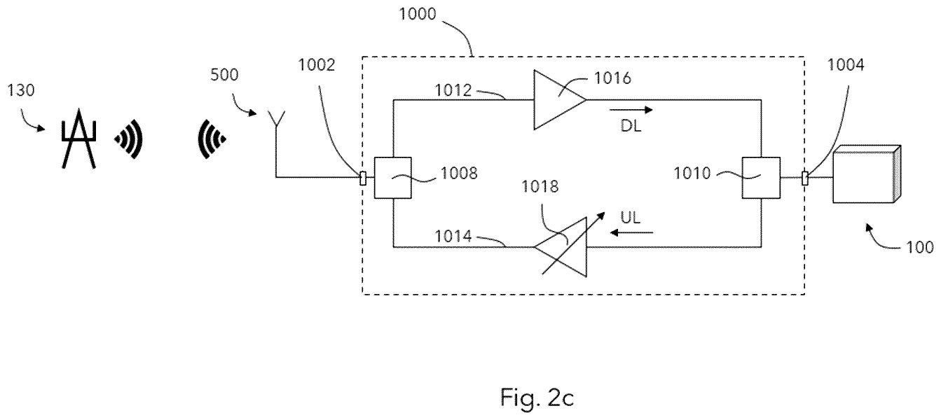

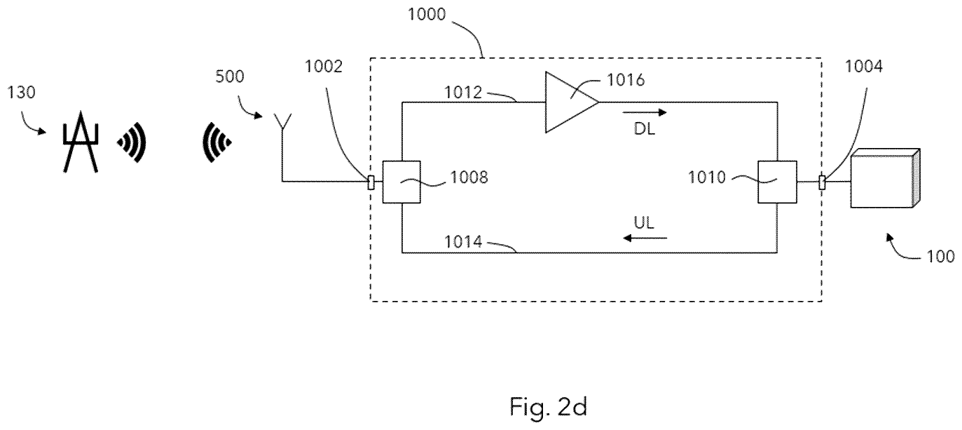

Referring to FIG. 2a there is shown a first “one way” amplify and “two-way” forward repeater 1000 according to the present invention. The repeater 1000 comprises a first port 1002 for connection to an external antenna 500 and a second port 1004 for connection to an RTD 100.

The repeater 1000 comprises a housing 1006 in which the ports 1002, 1004 are connection points to the antenna 500 and RTD 100 respectively. Within the repeater, the antenna port 1002 is connected to a first band selective duplex filter 1008, and the RTD port 1004 is connected to a second band selective duplex filter 1010. Between the filters 1008, 1010 there is provided a downlink channel path 1012 and a separate uplink channel path 1014. The downlink channel path 1012 carries data in the downlink direction DL only, from the antenna 500 to the radio terminal device 100, and the uplink channel 1014 path carries data in the uplink direction UL only, from the radio terminal device 100 to the antenna 500. The filters 1008, 1010 act to filter the frequency bands for uplink and downlink channels (i.e. FDD). The radio base station 130 connects to the antenna 500 over the air, and via the repeater 1000 to the RTD 100.

The downlink channel path has a low noise amplifier 1016 with a gain G_{DL1}.

In the embodiment of FIG. 2a the uplink channel path has a low noise amplifier 1018 with a gain G_{UL1} in series with an attenuator 1020 having an attenuation of A_{UL1}.

The RF repeater forward circuitry in the uplink channel path 1014, the amplifier 1018 and the attenuator 1020 are selected to achieve a “net-zero” gain circuitry on the uplink channel 1014. In other words, the attenuator value A_{UL1} and the amplifier gain G_{UL1} are selected to compensate for the system losses (i.e. the RF repeater circuitry insertion losses) and equate input RF power at the input of the repeater 1004 to output RF power at the output of the repeater 1002 (i.e. net zero gain). In this way the standardized maximum transmitted power of the selected RTD is controlled.

Advantageously, by using an attenuator before the LNA one can control the input RF power at the LNA as such not to exceed its maximum input and output RF power thresholds as such to compress or saturate the transmitted signal. Assuming an LNA that its maximum input power threshold is 10 dBm, having a gain of 21 dB and maximum output power threshold of 28 dBm, it is easily understood that inserting a 23 dBm signal power on the LNA without attenuation, the LNA will severely compress the transmitted signal (if the LNA survives). Assuming that the uplink channel path has a combined loss of 8 dB (4 dB before the LNA gain and 4 dB after the LNA gain—i.e. duplexer filter losses and the like), attenuating the 23 dBm signal power by 9 dB (23 dBm-4 dB−9 dB=10 dBm), the maximum input power threshold at the LNA is satisfied. However, adding the 21 dB LNA gain, the maximum output power threshold of 28 dBm is not satisfied and the LNA will compress the transmitted signal (i.e. 10 dBm+21 dB=31 dBm or 3 dB compression). To satisfy both the input and output power of the LNA, the attenuator should be selected to attenuate the input RF power signal as such not to exceed 6 dBm (i.e. 23 dBm−XdB=6 dBm or attenuator of XdB=17 dB in this example). Therefore, for the 6 dBm input signal power at the LNA, adding its 21 dB gain (6 dBm+21 dB=27 dBm) the LNA output power threshold is satisfied, thus the LNA will not compress or saturate. Knowing that at the LNA output we have 4 dB attenuation, the standardized maximum transmitted power is controlled to be at the desired 23 dBm (i.e. 27 dBm−4 dB=23 dBm).

Please note that different LNA specifications lead to different attenuator values, different transmitted input signal power lead to different attenuator values, and different system insertion losses lead to different attenuator values.

At the exemplary LTE and 5G technologies, the maximum transmit power levels for a radio terminal device can vary based on the specific RTD (or UE) category. The power levels are typically specified in terms of dBm (decibels per milliwatt) or watts. Herein below is a general overview:

### LTE (FDD) Maximum Transmit Power Levels (Uplink):

Category 1 (Cat 1) RTD: 20 dBm (0.1 W)
Category 2 (Cat 2) RTD: 20 dBm (0.1 W)
Categories 3 to 24 RTD: Power levels gradually increase, reaching up to 23 dBm (0.2 W) or higher for higher categories.

### LTE (TDD) Maximum Transmit Power Levels (Uplink):

Category 1 (Cat 1) RTD: 20 dBm (0.1 W)
Category 2 (Cat 2) RTD: 23 dBm (0.2 W)
Categories 3 to 24 RTD: Power levels gradually increase, reaching up to 23 dBm (0.2 W) or higher for higher categories.

### 5G NR (New Radio) Maximum Transmit Power Levels (Uplink):

NR Category 1 (NR Cat 1) RTD: 23 dBm (0.2 W)
Categories 2 to 15 RTD: Power levels gradually increase, reaching up to 26 dBm (0.4 W) or higher for higher categories.

It's important to note that these values are general guidelines, and the specific power levels may vary based on regional regulatory requirements, network configurations, and other factors. Additionally, these values represent uplink (transmission from the device to the network) maximum transmit power levels. Downlink (transmission from the network to the device) power levels may have different specifications. Accurate and detailed information is provided by standardization bodies such as 3GPP (for LTE) and 3GPP NR (for 5G) in their official technical specification documents.

In this way the maximum transmitted power for a selected RTD, at the input and output of the specific LNA is controlled without the need of an automatic gain controller (AGC) maintaining the quality of the re-transmitted signal without distortion due to LNA compression or saturation while at the same time the power control mechanism (uplink channel) of the radio terminal device is not compromised.

The net gain of the repeater 1000 in the uplink direction 1014 is zero. As such, for example, a signal transmission within a range of −40 dBm to 23 dBm (i.e. within the uplink power control dynamic range assuming a Category 3 to 24 device class maximum transmit power level) from the RTD 100 into the repeater 1000 will exit the repeater 1000 at the same range i.e. −40 dBm to 23 dBm (and not at the preset power levels of the AGC as would be the case with a prior art system).

### FIRST VARIATION OF THE FIRST EMBODIMENT

In the first embodiment, the combination of LNA 1018 and attenuator 1020 is used to obtain the desired gain to provide a net zero gain on the uplink channel. In many circumstances, an LNA 1018 having a gain equal to the system losses may not be commercially available, and as such combination with an attenuator may be the only way (or at least the most commercially feasible way) to provide the net zero gain.

Turning to FIG. 2b, a repeater 1000 is shown identical to the repeater 1000 of FIG. 2a with the exception that no attenuator is provided. In this instance, the gain of the LNA 1016, 1018 differs G_{DL1}>G_{UL1} and the LNA 1018 is selected to provide a net zero gain on the uplink channel path while its RF input and RF output power thresholds are satisfied in order not to compress or saturate the transmitted signal powers.

### SECOND VARIATION OF THE FIRST EMBODIMENT

Turning to FIG. 2c, a repeater 1000 is shown identical to the repeater 1000 of FIG. 2a with the exception that no attenuator or LNA is provided in the uplink channel path 1014, and a variable gain LNA 1018 is provided instead. The LNA 1018 can therefore be selected to provide a net zero gain on the respective uplink channel path 1014 and for the respective RTD device class maximum transmit power level specifications. Last but not least the LNA's RF input and RF output power thresholds are satisfied in order not to compress or saturate the transmitted signal powers.

### THIRD VARIATION OF THE FIRST EMBODIMENT

Turning to FIG. 2d, a repeater 1000 is shown identical to the repeater 1000 of FIG. 2a with the exception that no attenuator or LNA is provided in the uplink path 1014. There is no amplification in the uplink path 1014. This results in a net loss (negative gain) in the uplink path due to system losses. However, in this configuration we do not need to account for the RF input and RF output power in the uplink channel path (or the radio terminal device category) in order to fully operate the device with its uplink power control feature, maintain the quality of the re-transmitted signal without distortion and ensure that the maximum transmitted power of the selected RTD does not exceed its standardized levels. It will be noted that an amplifier 1016 is still present in the downlink path 1012.

### DESCRIPTION OF THE SECOND EMBODIMENT

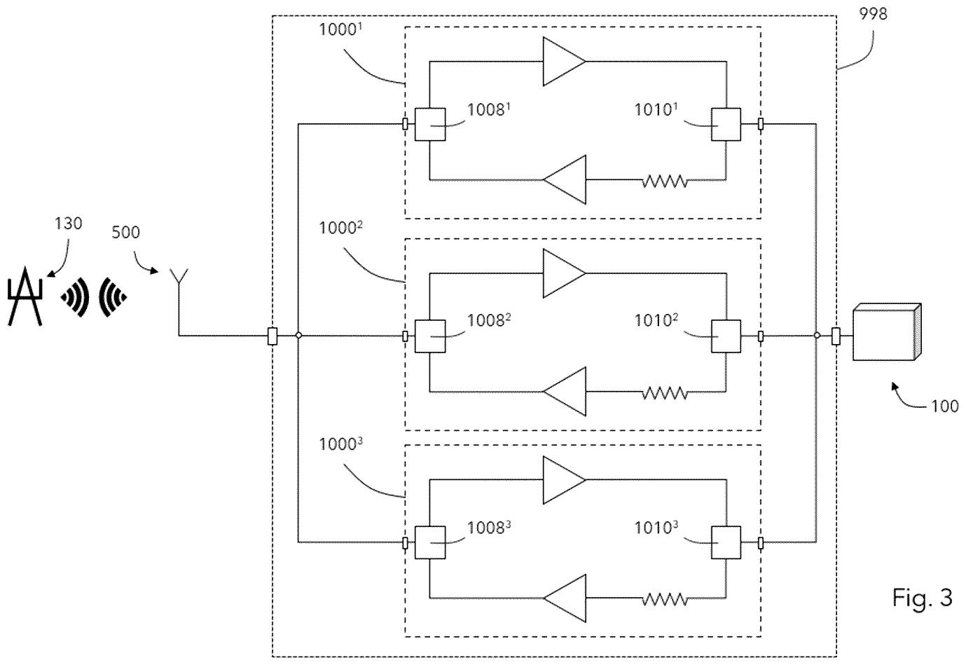

Referring to FIG. 3, the second embodiment is configured to operate with a single data stream (SISO configuration). This embodiment comprises a repeater 998 comprising three multiplexed band selective repeaters 1000¹, 1000², 1000³. The band selective repeaters are each identical in configuration to the repeater 1000 from the first embodiment or any variations thereof (the repeaters of FIG. 2a are shown by way of example).

In the second embodiment, each of the band selective repeaters 1000¹, 1000², 1000³ handles a separate frequency band. In this embodiment, band selective repeater 1000¹ handles the LTE band B20, band selective repeater 1000² handles the LTE band B8 and band selective repeater 1000³ handles the LTE band B28.

The input and output signals to each band selective repeater are split into the separate channels using duplex filters 1008 and 1010. For this embodiment, the filters 1008, 1010 of each band selective repeater (denoted by the superscript numbers) are configured to filter downlink and uplink channels.

The repeater 998 can therefore handle a multiband (Band 8, 20, 28) single data stream (SISO configuration).

### DESCRIPTION OF THE THIRD EMBODIMENT

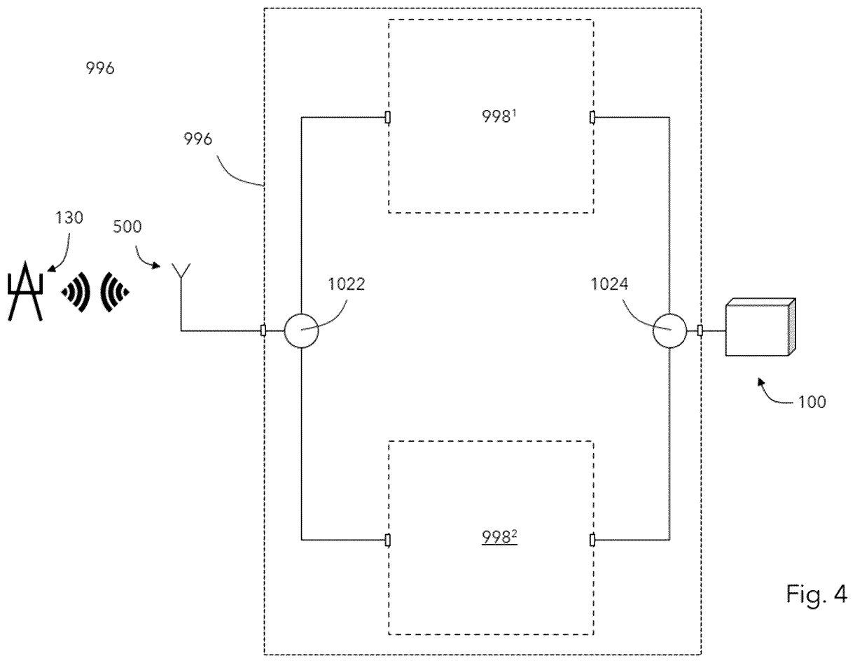

FIG. 4 is a further modification of FIG. 3, in which within a repeater 996 there are provided two multiplexed band selective repeaters 998¹, 998² per the second embodiment (which in turn each comprise three band selective repeaters 1000 per the first embodiment).

Downstream of the antenna connection port there is provided a first multiplexer such as a high/low pass filter 1022. Upstream of the RTD connection port there is provided a second multiplexer such as a high/low pass filter 1024. The filters 1022, 1024 separates the signals comprising the high frequency bands and the signals comprising the low frequency bands. The multiplexed band selective repeater 998¹ deals with the LTE bands B8, B20, B28 per FIG. 3, and multiplexed band selective repeater 998² handles the LTE bands B1, B3, B7.

### DESCRIPTION OF THE FOURTH EMBODIMENT

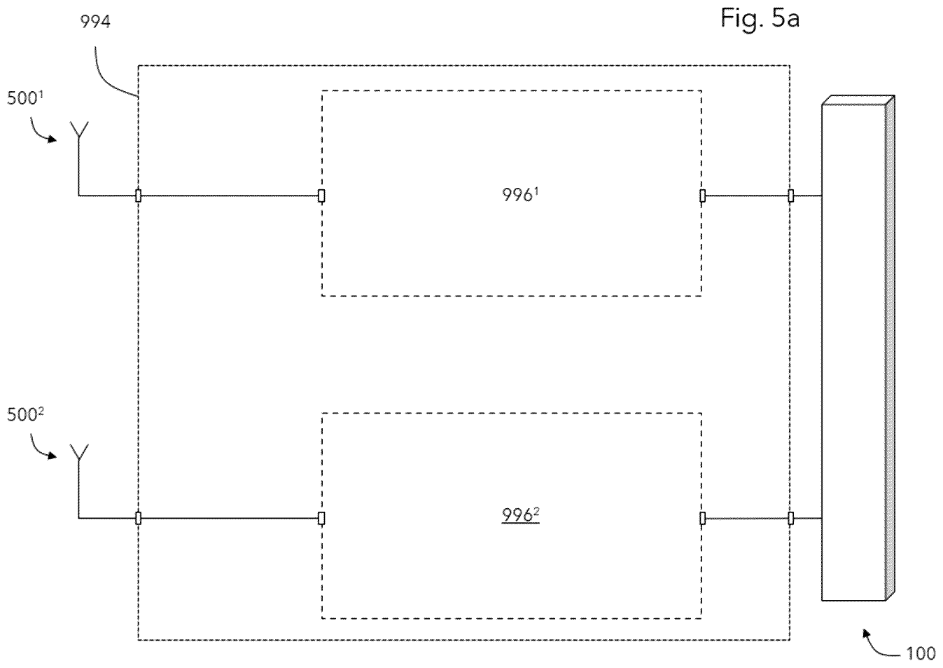

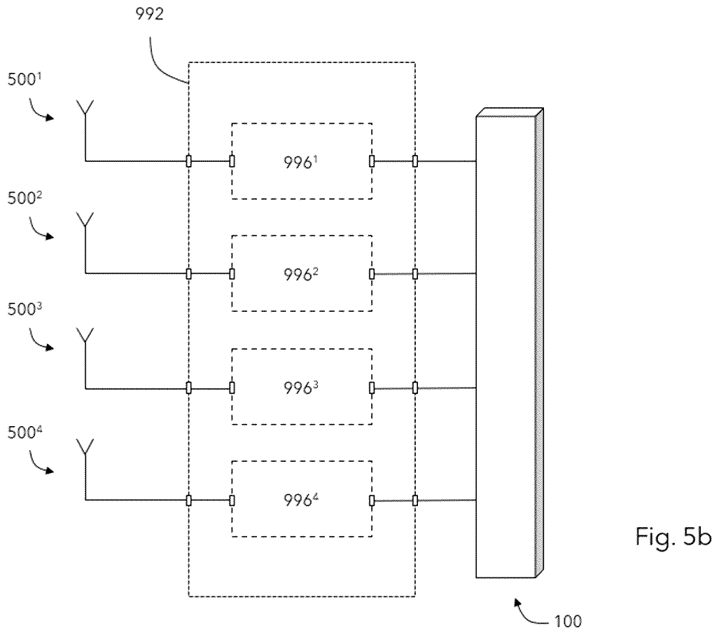

Referring to FIG. 5a, a further development of the embodiment of FIG. 4 is shown, adapted for dual data stream MIMO. The combined repeater is labelled 994.

A first RF repeater 996¹ with bands B1, B3, B7, B8, B20, B28 and a second RF repeater 996² with bands B1, B3, B7, B8, B20, B28 are positioned in parallel to form dual data stream MIMO. It will be noted that there are two antenna ports for connection to two antennas 500¹, 500². There are also two ports for direct connection to the RTD 100.

### VARIATION OF THE FOURTH EMBODIMENT

Referring to FIG. 5b, a further development of the embodiment of FIG. 5a is shown for a four datastream MIMO configuration, in which:
a first RF repeater 996¹ with bands B1, B3, B7, B8, B20, B28;
a second RF repeater 996² with bands B1, B3, B7, B8, B20, B28;
a third RF repeater 996³ with bands B1, B3, B7, B8, B20, B28; and,
a fourth RF repeater 996⁴ with bands B1, B3, B7, B8, B20, B28;
are positioned in parallel to form four data stream MIMO. The combined repeater is labelled 992.

It will be noted that any frequency band could be used—the above frequency bands are licensed LTE bands widely used in Europe. In other territories such as Asia or the USA different LTE frequency bands are used. Other technologies such as 5G or IEEE 802.11x may use different licensed or unlicensed frequency bands.

All RF repeaters 996 in this embodiment are connected on the same radio terminal device but on different antenna ports. The antennas 500 are shown as separate devices but may be part of the same antenna or under the same antenna housing. Multiple external antennas are required to be deployed at predetermined e-plane polarization or λ-multiple spacing using identical cablings (i.e. length and type) in order that signal transmissions and receptions from each antenna are uncorrelated for MIMO to perform.

### DESCRIPTION OF THE FIFTH EMBODIMENT

According to a fifth aspect of the present invention, the present invention may be utilised with the applicant's prior and co-pending applications as follows.

The “one way” amplify and “two-way” forward repeater according to the present invention may be employed with the applicant's 3skelion™ system as described in WO 2016/087431 A1, which is hereby incorporated herein by reference where permitted. In that application, a repeater system is provided in which at least one scanning antenna is configured to determine an optimum azimuth heading. A donor antenna is then configured to be directed to that heading to provide the optimal signal. In one embodiment the scanning and/or donor antennas may be moveable, and in another embodiment they may be a plurality of antennas connected to an RF switch.

The “one way” amplify and “two-way” forward repeater of the present invention can be connected to the donor antenna(s) to further improve the applicant's earlier system.

In another example, the present invention may be implemented with applicant's published patent application WO 2024/017902 A1. In that application, a multi-directional antenna system is provided having a plurality of directional donor antennas, each of which is oriented in a different direction to communication with different respective base stations. Each antenna is connected to a separate repeater and configured to serve a subset of users within a single hotspot.

The “one way” amplify and “two-way” forward repeater of the present invention can be used with each of the donor antennas to improve such a system.

In a still further example, applicant's unpublished patent application GB2308012.0 discloses a self-organising directional antenna system that is automatically directed in the horizontal (azimuth) plane to establish communication with the radio base station (RBS) that provides the radio terminal device in use with optimum connectivity performance. The present invention may be combined with such a system to improve it.

### DESCRIPTION OF THE SIXTH EMBODIMENT

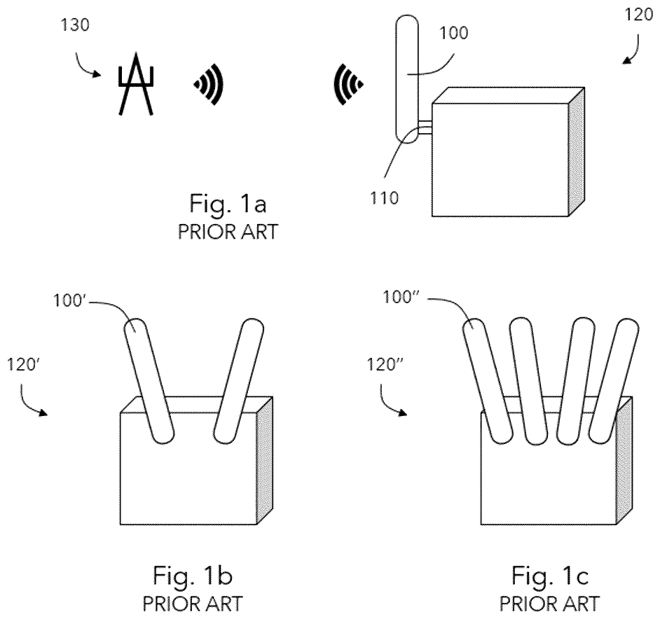

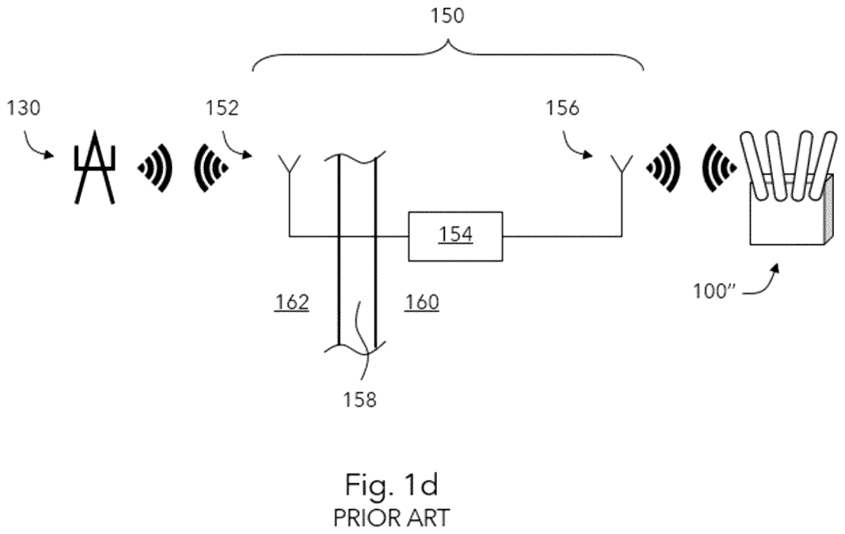

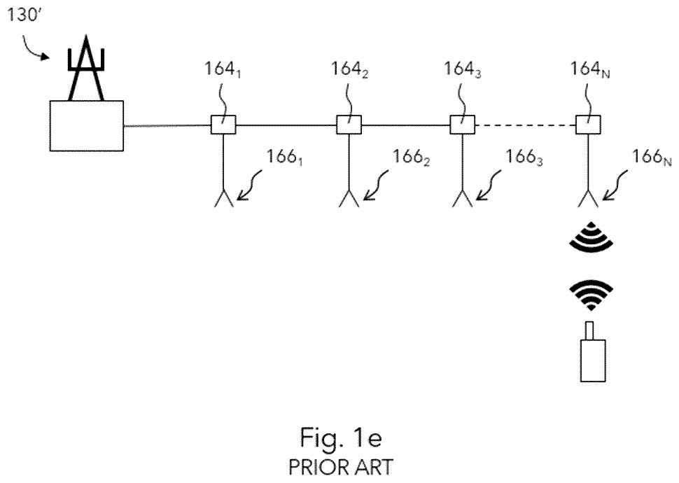

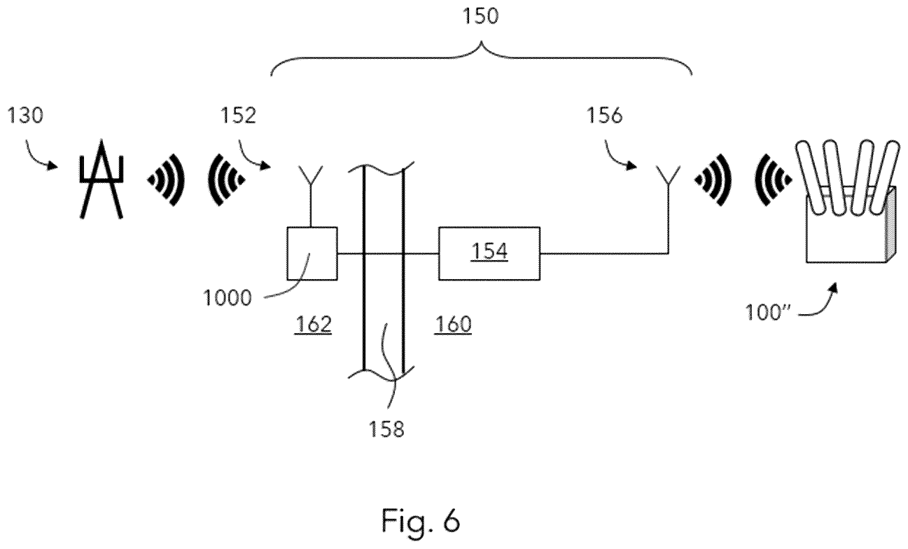

Referring to FIG. 6, a “one way” amplify and “two-way” forward repeater 1000 according to the present invention (per the first embodiment) is directly connected to a cascaded amplify-and-forward (AF) bi-directional or “two-way”) RF repeater 154 of the prior art as shown in FIG. 1d. In such configuration the repeater of the present invention is deployed as a pre-amplifier of the prior art amplify-and-forward (AF) bi-directional or “two-way” RF repeater 154. As shown in FIG. 6, in this embodiment the repeater 1000 is provided external to the wall 158 with the two-way repeater 154 inside the wall 158.

Advantageously, the downlink gain of the repeater of the present invention may be deployed as a downlink channel pre-amplifier to the prior art repeater in order to compensate the respective interconnection RF cable losses, thus offering increased signal to interference and noise ratio leading to upgraded MCS and eventually to higher downlink channel network speeds and throughput rates for the radio terminal devices serviced by the prior art repeater. It will be appreciated that since a transmitter is directly connected on the transmitting antenna (via the repeater circuitry), the repeater 1000 does not need an amplifier to forward the transmitted signals from the connected transmitting device—in this embodiment the prior art amplify-and-forward (AF) bi-directional or “two-way” RF repeater 154.

### DESCRIPTION OF THE SEVENTH EMBODIMENT

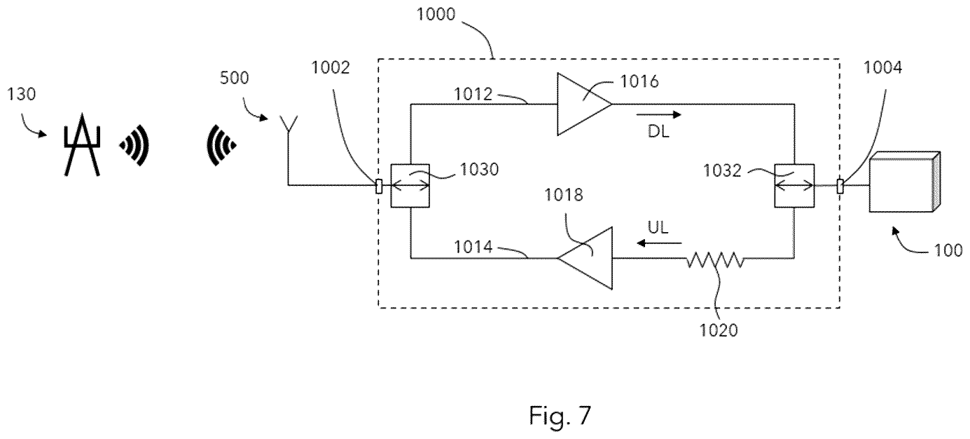

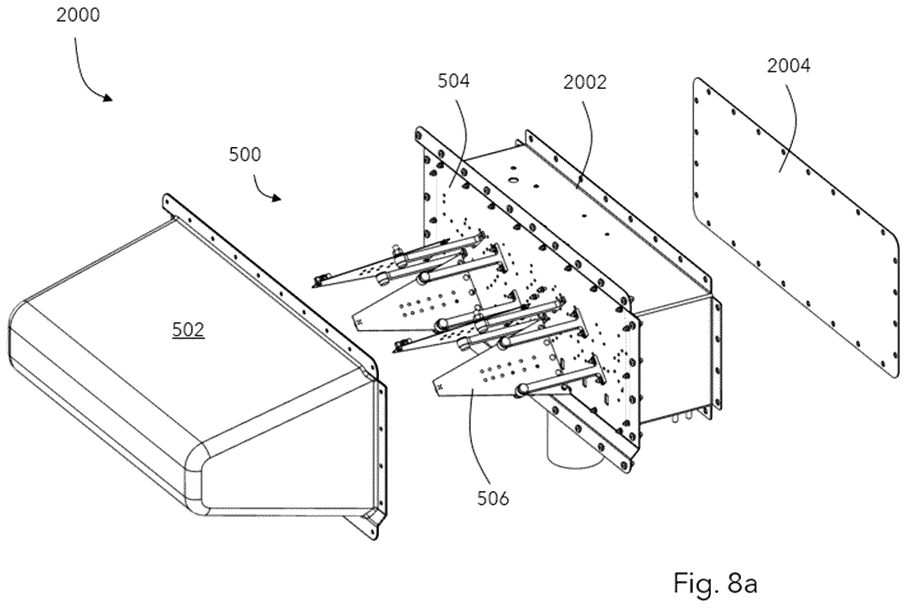

In a further embodiment, the system is combined with TDD. Referring to FIG. 7, a TDD (as opposed to FDD) embodiment is shown in which instead of filters, timed RF switches 1030, 1032 are provided. In 4G and 5G Time-Division Duplex (TDD) systems, the switching times between the uplink (UL) and downlink (DL) channels depend on the specific configuration and implementation of the network. Generally, in TDD, there's a special subframe configuration that defines the ratio of time allocated for uplink and downlink transmission. TDD systems use a frame structure where the transmission time is divided into subframes. Within each frame, there are specific subframes designated for uplink or downlink transmission. The switching between uplink and downlink for the RF switches 1030 and 1032 happens within these designated subframes.

In a 5G NR (New Radio) TDD, one of the common TDD configurations is the 1 millisecond (ms) subframe, which is further divided into DL and UL slots. The specific timing details can vary based on the subframe configuration, but as an example, the standard TDD subframe in 5G NR has the following structure:
Subframe duration: 1 ms
Number of slots per subframe: Typically 2 slots
DL-UL switch point: Usually, the switch point is in the middle of the subframe.

For example, in a TDD subframe with two slots, the switch point could be at 0.5 ms, meaning that the first half of the subframe is allocated to downlink transmission, and the second half is allocated to uplink transmission. However, it's essential to note that the exact configuration may vary depending on the specific TDD configuration and deployment, as such the RF switching times in the “one way” amplify and “two-way” forward repeater of the present invention should be defined accordingly.

### DESCRIPTION OF THE EIGHT EMBODIMENT

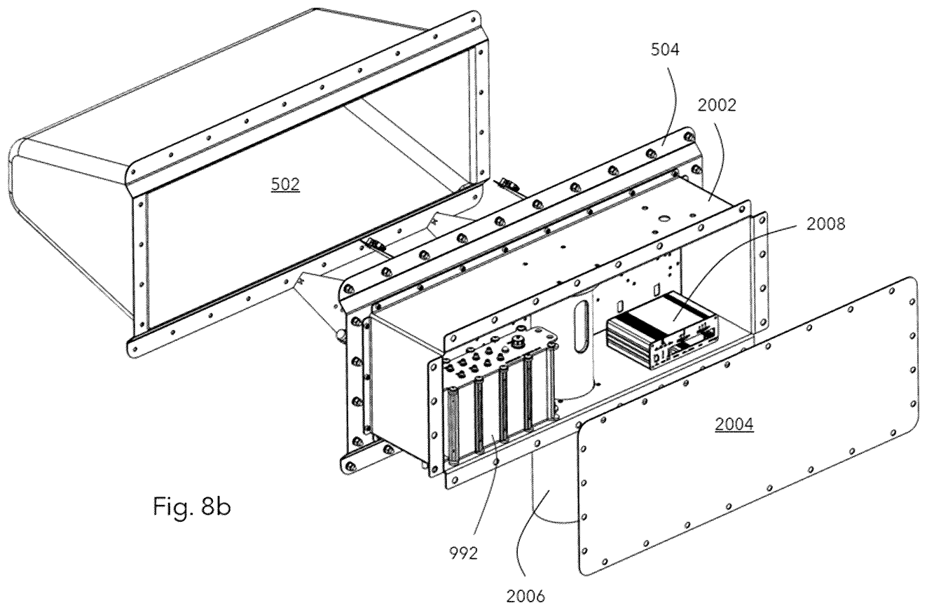

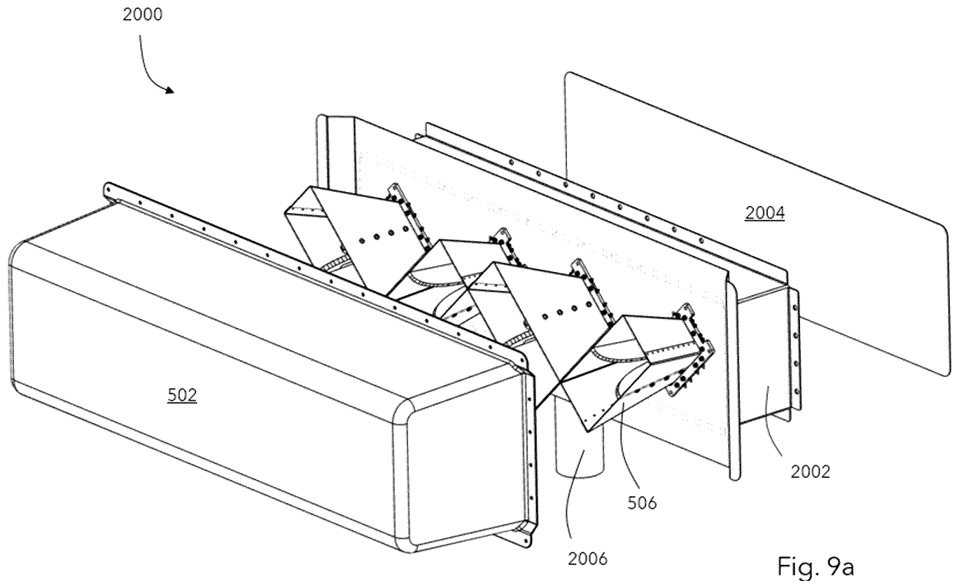

Referring to FIGS. 8a and 8b there is shown a combined antenna, repeater and RTD apparatus 2000 according to the present invention.

The apparatus 2000 comprises an antenna 500. The antenna is an LDPA (broadband) antenna having a radome 502, a backplane 504 and a plurality of four members 506 extending normal to the backplane 504, each member having a radiating element disposed thereon.

On a second side of the backplane 504, opposite to the radiating elements, there is provided a housing 2002 having a closure 2004. The housing 2002 is mounted on a pole member 2006.

Within the housing there is provided a repeater 992 according to the present invention (as described above). The repeater is configured for four data stream MIMO utilising the four antenna radiating elements. An RTD in the form of a CPE, IoT device or modem/router 2008 is provided, connected to the repeater 992. The CPE, IoT device or modem/router 2008 is positioned within the housing 2002 connected to the antenna.

### DESCRIPTION OF THE NINTH EMBODIMENT

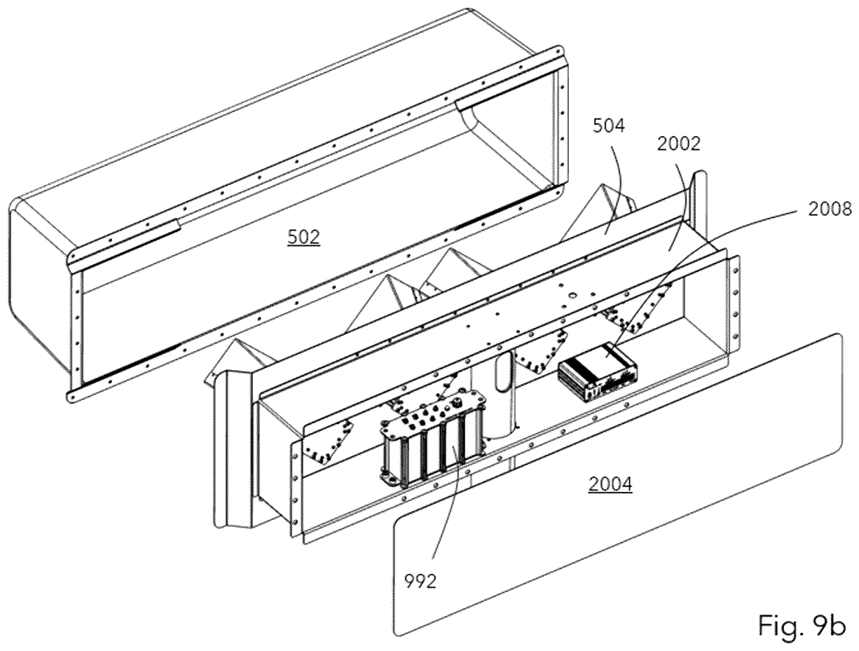

The ninth embodiment (FIGS. 9a and 9b) is similar to the eighth, and has the same reference numerals. The antenna 500 is broadband (covers all bands 1,3,7,8,20,28) on 4 data stream MIMO configuration. The antenna of FIGS. 9a and 9b is a metal Vivaldi-Horn type antenna, which although more expensive than the PCB antenna of FIGS. 8a and 8b is more efficient.

In both the eight and ninth embodiments, it will be observed that the four data stream MIMO antenna deployment, the repeater and RTD can be rotated as a single unit about a vertical (azimuth) steering axis if desired. Since RF repeaters boost the radio signal received at their input, depending on where the antenna is directed, the signal strength level of the re-transmitted radio base station is fully dependent on the four data stream MIMO antenna accurate alignment.

The system of the eight and ninth embodiments is a self contained, IP rated unit, and can be easily installed external to a property or vehicle (it is expected that IP44 would be the minimum standard, although ideally this should be higher, such as IP65). Only the connection of an e.g. ethernet cable to the RTD to an internal access point or similar is required. Therefore, assuming the installation complexity of multiple antennas positioned at predetermined E-plane polarizations or λ-multiple spacings in order that signal transmissions and receptions of each to be uncorrelated for MIMO to optimally perform (including cabling) there are significant advantages with respect to ease, accurate and precise installation and alignment compared to the prior art.

### DESCRIPTION OF THE TENTH EMBODIMENT

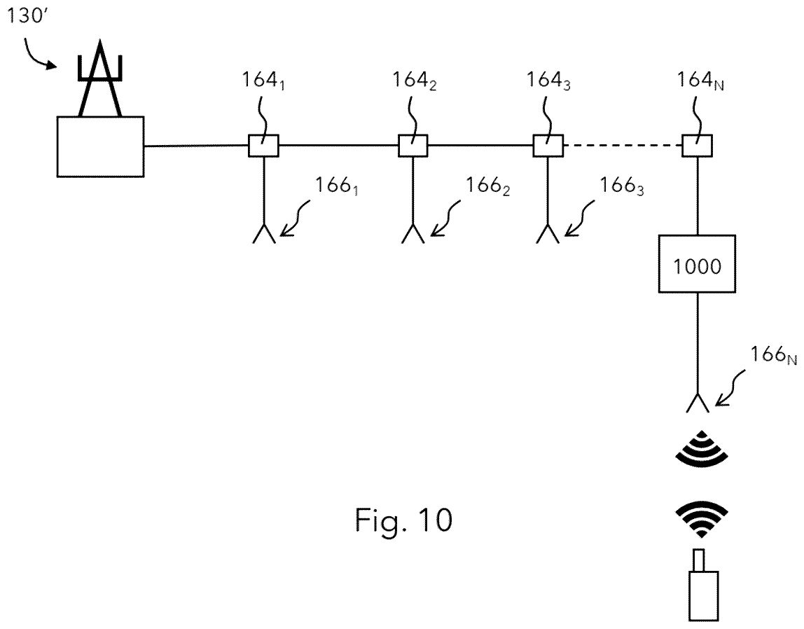

Referring to FIG. 10, a modified system comparable to the prior art system of FIG. 1e is shown. In this modified system, a direct connect “one-way” amplify and “two-way” forward repeater 1000 is provided between the splitter 164_{N} and service antenna 166_{N} according to the present invention.

The “one way” amplify and “two-way” forward repeater 1000 is configured to provide net zero gain on the downlink channel (amplification is not allowed for the exact same reasons described for the radio terminal device). Positive gain is provided in the uplink channel between the radio terminal devices and the RBS, due to the inherent RF power attenuation introduced by the Distributed Antenna System (DAS). This configuration overcomes the uplink channel losses resulting from the multiple splitter losses and the long coaxial cable runs of the DAS which may be in the region of 10-20 dB.

### Variations

In the aforementioned embodiments, the “one way” amplify and “two-way” forward repeater in the uplink channel has net zero or negative gain. Equally, the “one way” amplify and “two-way” forward repeater may be configured to have net zero or negative gain on the downlink channel.

Direct connect of a “one way” amplify and “two-way” forward repeater to a radio base station deployed on an indoor distributed antenna system (DAS).

It will be appreciated that since a transmitter is directly connected on the broadband antenna (via the repeater circuitry), the repeater does not need an amplifier to forward the transmitted signals from the connected transmitting device—in this embodiment the radio base station.

This configuration clearly improves the signal to interference and noise ratio in the uplink channel path leading to upgraded MCS and eventually to higher upload network speeds and throughput rates, not to mention the extended indoor coverage when the radio links are uplink limited.

1. A repeater system comprising:
at least one antenna port;
at least one RTD/RBS port for direct, wired connection to a radio terminal device (RTD) or radio base station (RBS);
a plurality of band selective amplify and forward repeater circuits between the at least one antenna port and the at least one RTD/RBS port.

2. A repeater system according to claim 1, wherein each amplify and forward repeater circuit has net zero gain or negative gain on one channel path.

3. A repeater system according to claim 2, wherein:
the RTD/RBS port is an RTD port for direct, wired connection to a radio terminal device (RTD).

4. A repeater system according to claim 3, wherein each amplify and forward repeater circuit has net zero gain or negative gain on the uplink channel path.

5. A repeater system according to claim 1, comprising:
a plurality of antenna ports;
a plurality of RTD ports;
to support MIMO operation.

6. A repeater system according to claim 5, comprising:
two antenna ports;
two RTD ports;
to support 2 data streams for MIMO operation.

7. A repeater system according to claim 5, comprising:
four antenna ports;
four RTD ports;
to support 4 data streams for MIMO operation.

8. A repeater system according to claim 2, wherein the channel path with net zero gain or negative gain comprises an amplifier.

9. A repeater system according to claim 8, wherein the channel path with net zero gain or negative gain comprises an attenuator in-line with the amplifier.

10. A repeater system according to claim 2, wherein each of the plurality of band selective amplify and forward repeater circuits has negative gain on one channel path, wherein said channel path does not have an amplifier, the other channel path comprising an amplifier.

11. A repeater system according to claim 1, comprising an RTD connected to the at least one RTD/RBS port, wherein the plurality of band selective amplify and forward repeater circuits are configured such that the uplink signal power at the at least one antenna port is the same as the uplink signal power at the at least one RTD/RBS port.

12. A repeater system according to claim 1, comprising an RTD connected to the at least one RTD/RBS port, wherein the plurality of band selective amplify and forward repeater circuits are configured such that the uplink signal power at the at least one antenna port is less than the uplink signal power at the at least one RTD/RBS port.

13. A self-contained repeater unit comprising:
a repeater system according to claim 1;
a radio terminal device (RTD) connected to the at least one RTD/RBS port;
an antenna connected to the at least one antenna port.

14. A self-contained repeater unit according to claim 13, wherein the radio terminal device (RTD) and the repeater system are contained in a housing attached to the antenna.

15. A self-contained repeater unit according to claim 14, wherein the radio terminal device (RTD) and the repeater system are contained in a housing attached to the antenna mounting plane.

16. A self-contained repeater unit according to claim 13, wherein the self-contained repeater unit is mountable on an elongate member for azimuth steering as a single unit.

17. A self-contained repeater unit according to claim 13, wherein the one or more antennas comprises one or more directional antennas.

18. A self-contained repeater unit according to claim 13, comprising a plurality of antennas positioned at predetermined E-plane polarizations or λ-multiple spacings.

19. A self-contained repeater unit according to claim 14, wherein the housing is IP rated.

20. A self-contained repeater unit according to claim 13, wherein the radio terminal device is customer premises equipment (CPE).

21. A self-contained repeater unit according to claim 20, wherein the customer premises equipment (CPE) is a modem/router.

22. A self-contained repeater unit according to claim 13, wherein the radio terminal device is an IoT device.

23. A distributed antenna system comprising:
a repeater system according to claim 1;
a radio base station (RBS) connected to the at least one RTD/RBS port;
a service antenna connected to the at least one antenna port;
wherein each amplify and forward repeater circuit has net zero gain or negative gain on the downlink channel path between the RBS and the service antenna.

24. A repeater assembly comprising:
a repeater system according to claim 1;
a two-way repeater connected to the at least one RTD/RBS port;
a donor antenna connected to the at least one antenna port;
wherein each repeater system has negative gain on the uplink channel path between the two-way repeater and the donor antenna.

25. A repeater antenna system, comprising:
a scanning antenna system comprising one or more scanning antennas, wherein the one or more scanning antennas are configured to receive, for at least a first azimuth heading value and a second azimuth heading value, data comprising mobile communication signal and network parameters,
a donor antenna system comprising one or more antennas, wherein the one or more antennas are configured to receive and transmit mobile communication signals, wherein the donor antenna system is connected to a repeater system according to claim 1;
a controller connected to the scanning antenna system and the repeater system according to claim 1, wherein the controller is configured to:
receive, process and compare the received mobile communication signals for the at least first azimuth heading value and the second azimuth heading value;
determine whether the first azimuth heading value or the second azimuth heading value provides optimal network and signal parameters according to predefined criteria; and
control connectivity of the repeater system according to claim 1 with the one or more donor antennas of the donor antenna system in accordance with the determination.

26. A multi-directional antenna system for a hotspot, the system comprising:
a plurality of directional donor antennas, each antenna oriented in a different direction such that each antenna has a different dominant radio base station in use;
at least one repeater system according to claim 1;
wherein:
each directional donor antenna is connected to the at least one repeater system.

27. A self-organizing directional antenna system, comprising:
a scanning antenna having a first horizontal beam width, the first antenna connected to a processor configured to establish communication between the scanning antenna and a radio base station (RBS);
a radio terminal station (RTS);
an RTS antenna system comprising at least one RTS antenna, the at least one RTS antenna having a second horizontal beam width, the second horizontal beam width being narrower than the first horizontal beam width;
a repeater system according to claim 1, the at least one RTS antenna connected to the at least one antenna port; and,
a controller configured to:
receive data identifying a RBS;
determine the location of the RBS;
using the location of the RTS antenna, and the position of the RBS, control the RTS antenna system to connect the RTS antenna to the RBS.
